(19) United States
(12) Patent Application Publication
(10) Pub. No.: US 2023/0191275 A1
(43) Pub. Date: Jun. 22, 2023

(54) METHODS AND COMPUTER-READABLE MEDIA FOR GRAPHICAL IMAGE MANIPULATION

(71) Applicant: Envegami, LLC, Hartwood, VA (US)

(72) Inventors: Christopher Frederick CONRAD, Fredericksburg, VA (US); John Joseph Conrad, Hanover, PA (US)

(21) Appl. No.: 18/083,290

(22) Filed: Dec. 16, 2022

Related U.S. Application Data
(60) Provisional application No. 63/291,060, filed on Dec. 17, 2021.

(51) Int. Cl. A63H 33/16; G06T 3/40; G06T 3/60; G06T 7/10

(52) U.S. Cl. CPC A63H 33/16; G06T 3/40; G06T 3/60; G06T 7/10; G06T 2207/20101

(57) ABSTRACT

A computer-implemented method for creating a digital canvas for printing on a foldable medium enables a user to create custom designed folded objects, such as custom designed origami envelopes. The method involves receiving a specification and a user input, and placing an image at a desired location within the digital canvas based on the specification and the user input. The specification comprises a first data set describing an intermediate configuration of the folded object and a second data set describing a folded configuration of the folded object. The user input defines a position and/or an orientation of the image in at least one of the intermediate configuration and the folded configuration.

### TECHNICAL FIELD

The present invention relates generally to computer implemented methods for manipulating graphical images. Some embodiments have example applications for creating custom designed origami paper that may be used to construct an origami object displaying the custom designs.

### RELATED APPLICATION

This application claims priority from U.S. Patent Application No. 63/291,060 filed on Dec. 17, 2021 entitled “METHODS AND COMPUTER-READABLE MEDIA FOR GRAPHICAL IMAGE MANIPULATION”. This application claims the benefit under 35 U.S.C. § 119 of U.S. Patent Application No. 63/291,060 filed on Dec. 17, 2021 entitled “METHODS AND COMPUTER-READABLE MEDIA FOR GRAPHICAL IMAGE MANIPULATION”, which is incorporated herein by reference in its entirety for all purposes.

### BACKGROUND

Digital image editing systems provide a variety of different capabilities for altering or enhancing an image. Resizing, cropping, color transformations, and flaw remediation are popular editing functions featured in some current digital image editing software products. Some current digital image editing products allow a user to insert an image (e.g., a photograph, a clip art, etc.) into a digital canvas, slice the inserted image, and subsequently move, copy, save, or delete the sliced image from within the digital canvas.

Current digital image editing products and image packages, however, generally rely on the user to define the actual cutting lines for slicing an image, whether the lines be drawn manually (e.g., with a mouse, a touch screen pointer, etc.) or with computer assistance by employing a predefined slicing template. Once the sliced image components are formed, current digital image editing products generally rely on the user again to manually position, scale and/or rotate the image components within the digital canvas for their desired end purpose.

Illustratively, if the desired end purpose is to simply restore a portion of an image by adjoining two or more image components formed from slicing the original image, the accuracy of the result will depend on the user's editing skills and the power of the image editing tools being employed. The process would be time consuming and fraught with potential alignment issues, especially if the initial slicing was complex.

The challenges are exacerbated in more complex applications. For example, in applications that require the image components to be positioned at disparate areas of the digital canvas such that the image components accurately align to form the image when a medium (e.g., a paper, a cardstock, etc.) carrying the canvas is folded, the risk of misalignment increases if the placement of the image components within the canvas is attempted in a manual process. In other more complex applications, a digital canvas may comprise several different sets of image components, corresponding to several different images, that will need to be precisely oriented, scaled and/or positioned within the digital canvas to ensure that the different sets of component pieces come together to form the different images when the medium carrying the canvas is folded.

One example application is creating custom designed origami paper that may be used to construct an origami object displaying custom images when the origami object is folded into its folded configuration. In such applications, the precise orientation and/or placement of the component pieces within the digital canvas can depend even on the size and/or thickness of the medium carrying the digital canvas. The construction of an origami object, such as an origami envelope, can be a desirable exercise that promotes artistic expression, thoughtfulness and connection between individuals involved in the process (e.g., a sender has the pleasure of writing and folding a uniquely designed letter, while a recipient experiences the adventure of unfolding the letter before reading it).

Hence, there remains a need for means to address the limitations of current image editing programs for applications of the type described above. There remains a need for computer-implemented methods, computer readable media, and related systems that enable a user to create digital canvases comprising image components that are precisely oriented and/or positioned within the digital canvas.

The foregoing examples of the related art and limitations related thereto are intended to be illustrative and not exclusive. Other limitations of the related art will become apparent to those of skill in the art upon a reading of the specification and a study of the drawings.

### SUMMARY OF THE DISCLOSURE

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention relates to a computer-implemented method for creating a digital canvas. The digital canvas can be printed on a medium foldable into a folded object, such as an origami object. The method comprises the steps of receiving a specification and initializing a background of the digital canvas based on the specification. The specification may comprise a first data set describing an intermediate configuration of the folded object and a second data set describing a folded configuration of the folded object. The background is initialized to define an area corresponding to the size of the medium. After initializing the background, the method comprises receiving a user input defining a position and an orientation of an image in at least one of the intermediate configuration and the folded configuration, followed by placing the image onto the background at a desired location within the area. The desired location is selected based on the specification and the user-defined position and orientation of the image.

In some embodiments, the method comprises slicing the image into two or more image components based on the user input and the specification, and placing each of the two or more image components onto the background at respective locations within the area. The respective locations are selected based on the specification and the user-defined position and orientation. Placing the two or more image components onto the background may, optionally, involve rotating the two or more image components based on the specification and the user-defined position and orientation and/or scaling the two or more image components based on at least one of the user input.

In some embodiments, the first data set defines one or more fold lines of the intermediate configuration. In some embodiments, the second data set defines one or more fold lines of the folded configuration. In some embodiments, the first data set defines one or more intersections of the intermediate configuration. In some embodiments, the second data set defines one or more intersections of the folded configuration. The defined fold lines of the intermediate configuration and the defined intersections of the intermediate configuration may collectively define multiple panels on the digital canvas, the panels collectively forming a surface of the object in the intermediate configuration. The panels may include a first pair of corner panels and a second pair of corner panels. The first pair of the corner panels may have the shape of irregular quadrilaterals. The second pair of the corner panels may have the shape of right trapezoids.

In some embodiments, the defined fold lines of the folded configuration and the defined intersections of the folded configuration collectively define multiple panels on the digital canvas. The panels may form a front surface and a back surface of the object in the folded configuration. The panels may include a main central panel corresponding to the front surface of the object in the folded configuration and a pair of side panels collectively forming the rear surface of the object in the folded configuration. The main central panel may have the shape of a convex hexagon. The pair of side panels may have the shape of irregular quadrilaterals.

In some embodiments, the method comprises receiving first and second user inputs defining first and second positions and first and second orientations of first and second images in the intermediate configuration, followed by placing the first and second images onto the background at a location within the area based on the first and second data sets and the first and second user inputs. In some embodiments, the method comprises slicing the first image into image components based on the first user input and the first data set, and placing the image components onto the background at respective locations within the area, the respective locations selected based on the first user input and the first data set.

Another aspect of the invention relates to a method of constructing an origami object, such as an origami envelope. The method involves printing one or more digital canvases created using methods described herein, and folding the medium into the origami envelope by performing a sequence of folds. The sequence of folds are defined according to the intermediate configuration and the folded configuration.

Another aspect of the invention relates to a system of constructing a foldable object such as an origami object. The system comprises a computer for generating a digital canvas by performing method described herein, and a printing machine for printing the digital canvas onto a sheet. In some embodiments, the computer is a personal computer having dedicated applications. In other embodiments, the computer is a specialized computer. The printing machine may be a digital printer, a specialized printer, a printing machine, a printing press, or the like.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive. Features and advantages of the embodiments of the present invention will become apparent from the following detailed description, taken with reference to the appended drawings in which:

FIG. 1 shows a front surface of a rectangular sheet that may be folded into an origami envelope according to an example embodiment.

FIG. 2 shows a rear surface and exemplary fold lines of the FIG. 1 rectangular sheet.

FIG. 3 schematically illustrates the first fold and the second fold of an exemplary process for constructing the origami envelope.

FIG. 4 shows a first intermediate configuration of the origami envelope and schematically illustrates the third fold and the fourth fold of the process for constructing the origami envelope.

FIG. 5 shows a second intermediate configuration of the origami envelope and schematically illustrates the fifth fold and the sixth fold of the process for constructing the origami envelope.

FIG. 6A shows a back surface of the origami envelope in its folded configuration. FIG. 6B shows a front surface of the origami envelope in its folded configuration.

FIG. 7 is a flowchart of an exemplary computer implemented method of creating a digital canvas for printing on a sheet which is foldable into an origami object.

FIG. 8 shows a digital canvas created using the FIG. 7 method for printing on a first side of the sheet.

FIG. 9 shows a digital canvas created using the FIG. 7 method for printing on a second side of the sheet.

FIG. 10 depicts an exemplary Graphical User Interface (GUI) of an image editing system according to an example embodiment. FIGS. 10A-C show various exemplary features of the FIG. 10 GUI.

### DETAILED DESCRIPTION

The description which follows, and the embodiments described therein, are provided by way of illustration of examples of particular embodiments of the principles of the present invention. These examples are provided for the purposes of explanation, and not limitation, of those principles and operation of the invention.

By way of overview, one aspect of the invention relates to computer-implemented methods, computer readable media, and engines that enable a user to create one or more digital canvases comprising images and/or image components that are precisely oriented, positioned and sized, according to a specification, within the digital canvas. The one or more digital canvases can be subsequently printed on one or both sides of a medium (e.g., paper, cardstock, etc.). The medium can be folded into an object, such as an origami envelope. When the medium is folded into the object (e.g., by folding the medium along fold lines on the medium), the image components align together to form reassembled image(s). The reassembled image(s) can be formed and displayed at various surfaces of the object, including at surfaces that are visible when the object is in its final folded configuration and/or at surfaces that are visible when the object is in one of its intermediate configurations.

Other aspects of the invention include computer engines and/or graphical user interfaces (GUIs) that present the various stages of a folding process to a user, allowing the user to visualize and design the various intermediate configurations (i.e., intermediate “layers”) of their own customized folded object (e.g., origami object). In some embodiments, the engine is configured to receive one or more digital images, and based on a user input and a specification: automatically slice the image(s) into two or more image components, and automatically rotate, translate and/or scale the image components within the digital canvas. For the purposes of facilitating the description, the term “image” as used herein refers to a photograph, a picture, a clip art, text or any design that forms a part of an overall digital canvas for printing onto a medium. An “image” may be compressed, stored or otherwise represented in digital graphical formats including, but not limited to, .jpg, .png, .bmp, .gif, and .tif. For the purposes of facilitating the description, the term “digital canvas” as used herein refers to the area for printing on the medium. The area comprises images and/or image components that are rendered into a single composite graphic. A digital canvas may comprise a background of any color (e.g., red, green, blue, white, etc.) or design, and any suitable number of images and/or image components.

Illustratively, the engine provides the user with the ability to create custom designed paper having image components that align together to form coherent images at one or more surfaces of a folded object. Such surfaces can include those that are visible when the object is in a folded configuration or one of its intermediate configurations. In some cases, varying weights or sizes (e.g., thickness, width, length) of the medium can affect the creasing of the folded object, thereby requiring precise placement of the image components on one or both sides of the medium to ensure that the image components align together properly to form a coherent image when the medium is folded into the object. Methods and engines described herein can be configured accordingly to accommodate mediums of various different materials, shapes, sizes and/or thicknesses.

For clarity, the term “medium” as used herein refers to any material that can carry an image or written correspondence (e.g., a material having an image or text printed thereon), and has an adequate pliability for folding. Some examples of such “medium” include, but are not limited to, paper, cardstock, vinyl, and the like. For convenience and brevity, the term “paper” or “sheet” may be used herein from time to time in place of the term “medium”. It should be understood that the terms “paper”, “sheet”, and “medium” may be used interchangeably within the scope of the present disclosure.

Additional aspects of the invention will be described in more detail below with reference to the following example method of constructing an origami envelope from origami paper.

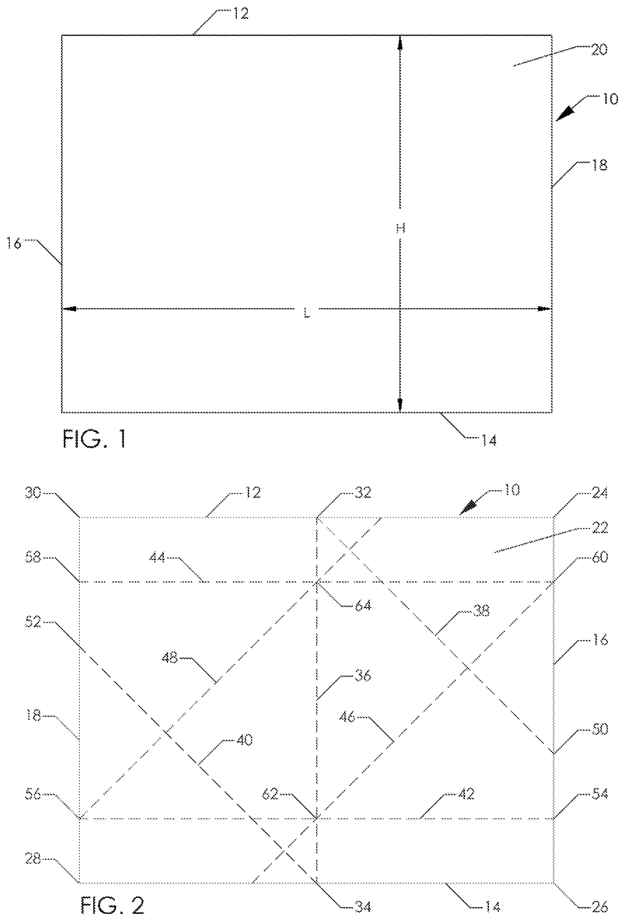

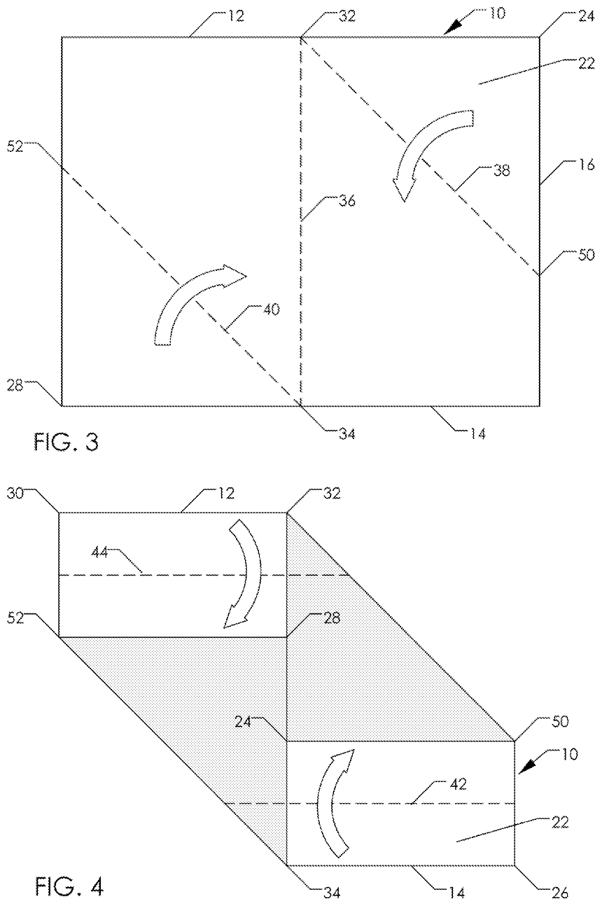

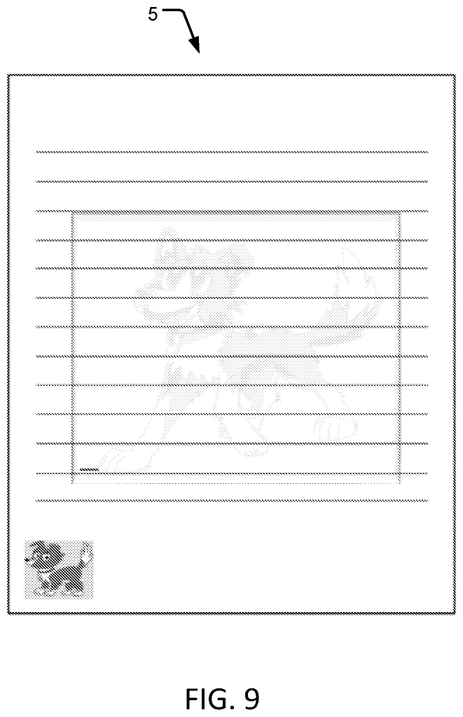

FIGS. 1-5 illustrate the initial configuration and various intermediate configurations of an origami envelope 2 (e.g., see FIG. 6) constructed from sheet 10 using an exemplary method. FIG. 1 shows a rectangular sheet 10 having a height dimension H and a length dimension L which is shorter than H. Sheet 10 may comprise images and/or image components printed thereon. Rectangular sheet 10 has four edges, defined herein as linear segments that collectively form the outer boundary of sheet 10. The four edges consist of a first long edge 12, a second long edge 14 that is parallel to the first long edge 12, a first short edge 16 that is perpendicular to long edges 12, 14, and a second short edge 18 that is parallel to the first short edge 16. Rectangular sheet 10 has two surfaces, defined herein by the two sides of sheet 10. The two surfaces consist of a first surface 20 and an opposing second surface 22 (e.g., see FIG. 2).

First surface 20 may have various image components printed thereon, as described in more detail elsewhere herein. Second surface 22 may act as the inside and/or provide the writing surface of origami envelope 2, as described in more detail elsewhere herein.

FIG. 2 illustrates various exemplary fold lines that define the creases of an origami envelope 2 in its folded configuration. For the purposes of facilitating the description, the term “fold line” is used herein to refer to a line segment along which a portion of sheet 10 is intended to be folded. For the purposes of facilitating the description, the term “crease” is used herein to refer to the multilayered medium formed at a fold line after performing an origami fold along the fold line. For the purposes of facilitating the description, the term “node” is used herein to refer to a point located at the intersection of two edges, an edge and a fold line, or two fold lines. In some embodiments, sheet 10 comprises fold lines and/or nodes that are explicitly printed on first surface 20 and/or second surface 22.

In the example embodiment illustrated in FIG. 2, a first node 24 of sheet 10 is located at the intersection of top edge 12 and right edge 16, a second node 26 is located at the intersection of right edge 16 and bottom edge 14, a third node 28 is located at the intersection of bottom edge 14 and left edge 18, a fourth node 30 is located at the intersection of left edge 18 and top edge 12, a fifth node 32 is located at the midpoint of top edge 12, and a sixth node 34 is located at the midpoint of bottom edge 14. A center line 36 of sheet 10 extends between the fifth node 32 and the sixth node 34.

As depicted in FIG. 2, origami envelope 2 may be constructed by employing six fold lines 38, 40, 42, 44, 46, 48. A first fold line 38 extends diagonally from the top edge midpoint 32 to a point 50 whose distance from the upper right corner 24 is equal to the distance from said corner 24 to the top edge midpoint 32. A second fold line 40 extends diagonally from the bottom edge midpoint 34 to a point 52 whose distance from the lower left corner 28 is equal to the distance from said corner 28 to the lower edge midpoint 34. The first fold line 38 and the second fold line 40 are parallel. A third fold line 42 is parallel to the bottom edge 14 and extends from a point 54 on the right edge 16 to a point 56 on the left edge 18 such that the constant distance from the bottom edge 14 is half the distance from the lower right corner 26 and the lower node 50 of the first fold line 38. A fourth fold line 44 is parallel to the top edge 12 and extends from a point 58 on the left edge 18 to a point 60 on the right edge 16 such that the constant distance from the top edge 12 is half the distance from the upper left corner 30 and the upper node 52 of the second fold line 40.

A fifth fold line 46 originates from the right edge 16 at the upper node 60 and extends through the node 62 formed by the intersection of the center line 36 and third fold line 42, terminating at a point on the bottom edge 14. A sixth fold line 48 originates from the left edge 18 at the lower node 56 and extends through the node 64 formed by the intersection of the center line 36 and fourth fold line 44, terminating at a point on the top edge 12. The fifth fold line 46 and the sixth fold line 48 are parallel. The fifth fold line 46 and the sixth fold line 48 are both orthogonal to first fold line 38 and second fold line 40.

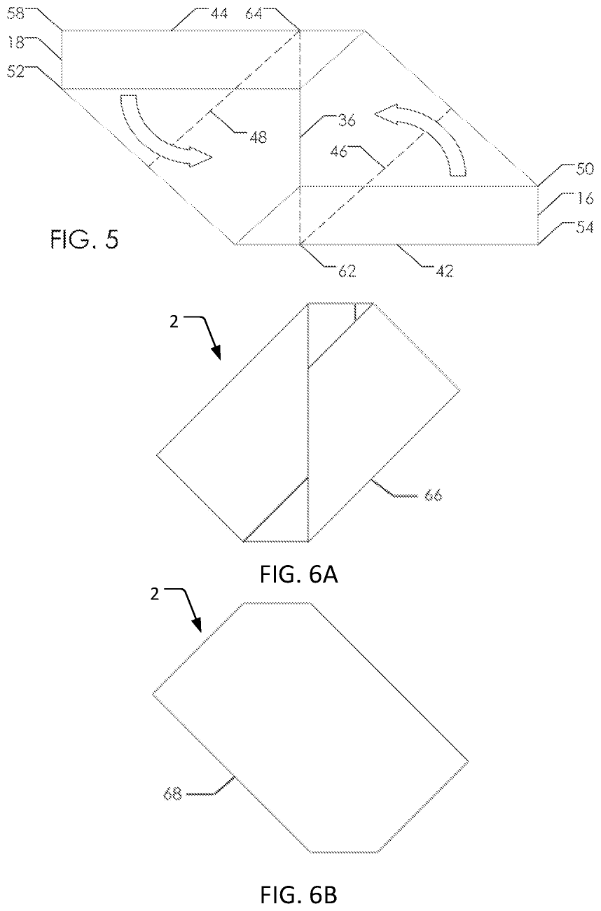

Referring now to FIG. 3, the first two folds required to construct origami envelope 2 from sheet 10 is shown from the perspective of the second surface 22. As illustrated in FIG. 3, the first fold is performed by folding upper right corner 24 of sheet 10 to center line 36 such that a folded portion of the top edge 12 (i.e., a portion extending from midpoint node 32 to right corner 24) aligns with center line 36 and a folded portion of the right edge 16 (i.e., a portion extending from the lower node 50 to the upper corner 24) becomes parallel to the bottom edge 14. A crease is formed along the entire first fold line 38. The second fold is performed by folding lower left corner 28 of sheet 10 to center line 36 such that a folded portion of bottom edge 14 (i.e., a portion extending from midpoint node 34 to left corner 28) aligns with the center line 36 and a folded portion of the left edge 18 (i.e., a portion extending from upper node 52 to bottom corner 28) becomes parallel to top edge 12. A crease is formed along the entire second fold line 40.

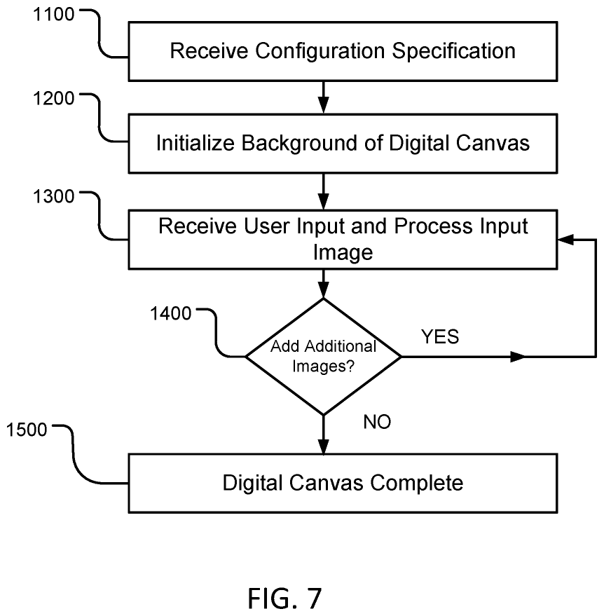

FIG. 4 shows a first intermediate configuration of origami envelope 2 (i.e., the configuration after performing the first and second folds) and the next two folds required to construct origami envelope 2. As illustrated in FIG. 4, a third fold is performed by folding a segment of bottom edge 14 bounded by bottom edge midpoint 34 and lower right corner 26 such that the edge is aligned with a segment between upper right corner 24 and lower node 50 of first fold line 38. A crease is formed along fold line 42. A fourth fold is performed by folding a segment of top edge 12 bounded by top edge midpoint 32 and upper left corner 30 such that the edge is aligned with a segment between lower left corner 28 and upper node 52 of second fold line 40. A crease is formed along fold line 44.

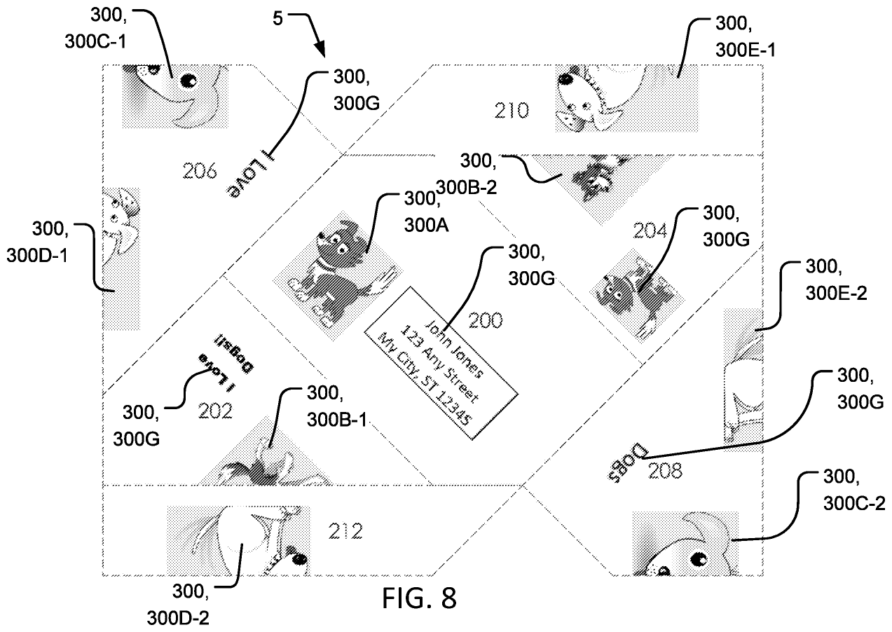

FIG. 5 shows a second intermediate configuration of origami envelope 2 (i.e., the configuration after performing the third and fourth folds) and the next two folds required to construct origami envelope 2. As illustrated in FIG. 5, a fifth fold is performed by folding lower node 54 on right edge 16 to meet upper node 64 of center line 36 such that a segment of the crease formed on third fold line 42 is aligned with center line 36. A sixth fold is performed by folding upper node 58 on left edge 18 to meet lower node 62 of center line 36 such that a segment of the crease formed on fourth fold line 44 is aligned with center line 36.

To complete the construction of origami envelope 2, the previously folded lower node 54 on right edge 16 is inserted under a first flap (i.e., a partial section of first crease line 38, created by the third fold) such that it overlaps with upper node 64 of center line 36. Next, the previously folded upper node 58 on left edge 18 is inserted under a second flap (i.e., a partial section of second crease line 40, created by the fourth fold) such that it overlaps with lower node 62 of center line 36.

FIGS. 6A-B show a folded configuration of origami envelope 2. FIG. 6A shows a back surface 66 of origami envelope 2 in its folded configuration. FIG. 6B shows a front surface 68 of origami envelope 2 in its folded configuration. Various intersections, represented by line segments traversing sheet 10, are visible at back surface 66. The front surface 66 of the envelope 2 has no visible intersection and displays a continuous portion of sheet 10.

As described above, aspects of the invention relate to computer implemented methods for automatically slicing an input image into two or more image components, followed by automatically rotating, translating and/or scaling the image components in a desired manner. In some embodiments, such methods can be used to create one or more digital canvases comprising image components that are located and/or oriented within the digital canvases according to a configuration specification. The digital canvases can be printed on one or both surfaces of sheet 10, which can be folded into a folded object. That is, such methods can be used to automatically place (i.e., position and orient) image components at locations that allow the image components to align together to form a reassembled image when sheet 10 carrying the image components is folded into the folded object (e.g., origami envelope 2).

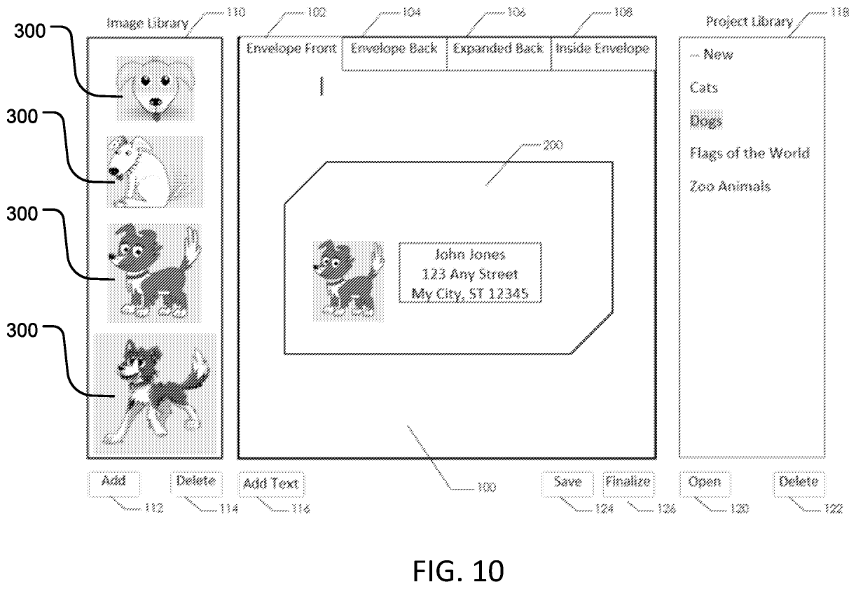

FIG. 7 is a flowchart illustrating an exemplary method 1000 of creating one or more digital canvases 5 for printing on one or more sheets 10. Method 1000 has example applications for creating custom designed paper. In such applications, sheet 10 carrying digital canvases 5 (e.g., having digital canvases 5 printed thereon) can be folded into a folded object, such as an origami envelope. Method 1000 may be implemented by a computer system, a computer engine, a software application, a web-based application, or the like.

Method 1000 begins at step 1100. Step 1100 comprises receiving a configuration specification. The specification may include information (e.g., data or data sets) which define the features of a folded object. As used herein, “folded object” means any object that may be created from a foldable material; such object may include, for example, an origami object (e.g. crane, flower, etc.), an envelope, a box, or the like. The specification may include information which defines the model of the folded object (e.g., crane, flower, envelope, box, etc.), the size of the folded object, the corresponding dimensions of sheet 10 required to construct the folded object, and other parameters of the model or folded object. In some embodiments, the specification comprises data sets describing an unfolded configuration of the folded object, data sets describing one or more intermediate configurations of the folded object, and/or data sets describing a folded configuration of the folded object. The data sets may define one or more fold lines of a particular configuration, one or more intersections of a particular configuration and/or one or more panels that collectively form a surface of the folded object in a particular configuration. Each data set may include one or more arrays or matrices of numbers that identify locations of the fold lines, the intersections, and/or the panels of sheet 10.

In some embodiments, the specification is selected by the user from a library storing one or more pre-defined specifications. In some embodiments, the specification is customized by the user according to the model and/or size of the folded object that is desired to be constructed. After receiving the specification at step 1100, method 1000 proceed to step 1200.

At step 1200, a background of the digital canvas 5 is initialized based on the specification. The background of the digital canvas 5 may be initialized based on, for example, the size and/or model of the folded object as defined in the configuration specification. The background of digital canvas 5 is initialized to define a size of digital canvas 5 corresponding to the size of sheet 10 (which may be selected based on the size and/or model of the folded object). In some embodiments, the background is white (i.e., blank). In other embodiments, the background is colored and may optionally include a design or pattern. After initializing the background at step 1200, method 1000 proceed to step 1300.

In some embodiments, step 1200 comprises initializing the backgrounds of two digital canvases 5 based on the specification. In such embodiments, the first digital canvas 5 may be configured for printing on a first side of sheet 10 and the second digital canvas 5 may be configured for printing on a second side of sheet 10.

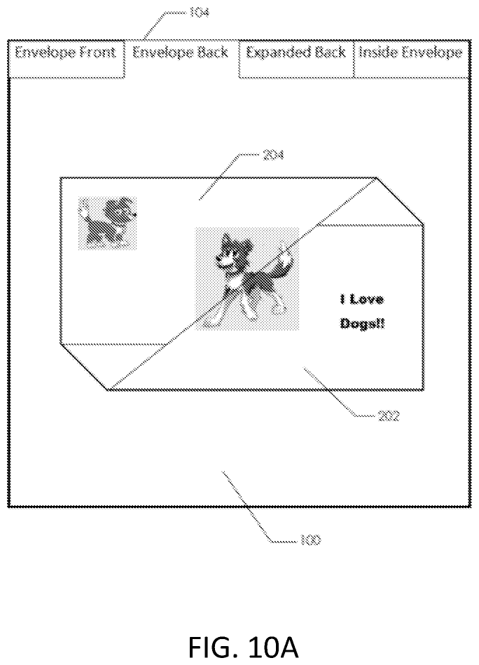

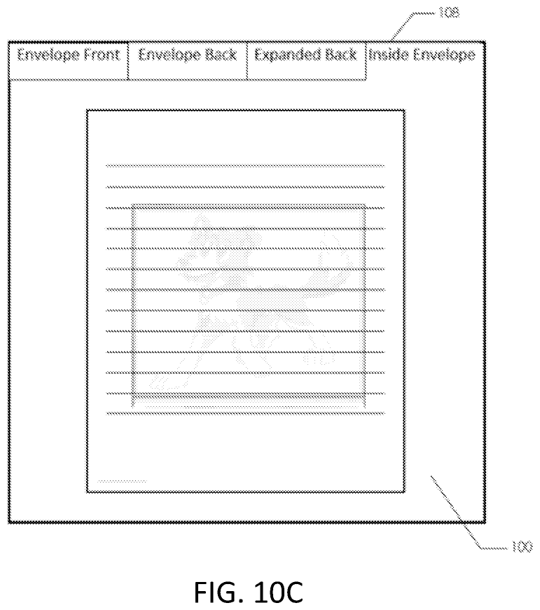

Step 1300 comprises processing an image 300 based on the specification and an input from the user. Step 1300 may comprise receiving, loading, or otherwise obtaining an image 300. The image 300 may be a photograph, clip art, stock image, text box, or any other image as described above (e.g., see FIG. 8). The image 300 is processed based on the specification and the user input. Some examples of user inputs include, but are not limited to, an input defining the location of the image within a configuration of the folded object (as specified by the specification), an input defining the orientation of the image within a configuration of the folded object (as specified by the specification), an input defining the size of the image, an input defining the tone or color temperature of the image, an input defining the transparency of the image, etc. The user input may be provided by the user through a graphical user interface (GUI), as illustrated in FIG. 10 and described in more detail below.

Illustratively, the step of processing image 300 typically comprises one or more of: slicing the image 300 into two or more image components, positioning the 300 or image components thereof at a desired location within one or more digital canvases 5 based on the specification and user input, and rotating image 300 or image components thereof to a desired orientation within digital canvas 5 based on the configuration specification and the user input. For example, step 1300 may comprise positioning and orienting a first image component at a first location of a first digital canvas 5 and positioning and orienting a second image component at a second location of a second digital canvas 5 (where the first image component and the second image component may align together to form an image when the sheet 10 carrying the digital canvases 5 is folded).

In some embodiments, the specification comprises data sets which define lines that divide digital canvas 5 into a plurality of panels. In the example embodiment illustrated in FIG. 8, the specification is defined according to an origami envelope 2 of the type illustrated in FIGS. 1-6. In such embodiments, the specification comprises data sets that divide digital canvas 5 into a main central panel 200, a pair of side panels 202, 204, a first pair of corner panels 206, 208, and a second pair of corner panels 210, 212. As depicted in FIG. 8, main central panel 200 may have the shape of a convex polygon, side panels 202, 204 may have the shape of an irregular quadrilateral, corner panels 206, 208 may have the shape of an irregular quadrilateral, and corner panels 210, 212 may have the shape of a right trapezoid.

In other embodiments, the specification is defined according to other models of origami objects. In such embodiments, digital canvas 5 may be divided into different numbers of panels and/or panels with different shapes.

As described above, step 1300 comprises automatically processing an input image 300 based on the specification and/or user input. Exemplary types of automatically performed image processing are described in more detail below with reference to the different images 300 shown in FIG. 8. In the example illustrated in FIG. 8, a user input specifies the desired location of first image 300A to be at a front surface of the folded configuration of the origami envelope 2 (as defined by the configuration specification). The desired location may be specified by the user through, for example, dragging and dropping image 300A in a working area 100 of a GUI of the type shown in FIG. 10. For first image 300A, step 1300 comprises automatically rotating first image 300A to its desired orientation within main central panel 200 based on the user input (e.g., an input specifying the location of image 300A within a front panel section 200 of origami envelope 2 in its folded configuration) and the specification (e.g., data sets describing the configurations of origami envelope 2).

After processing image 300 in step 1300, method 1000 proceeds to decision step 1400. Decision step 1400 comprises determining whether additional images should be added to digital canvas 5. The determination may be made based on a user input or a predefined setting. If it is determined at decision step 1400 that additional images 300 should be added, then method 1000 returns to step 1300 for processing additional input images 300.

Step 1300 may be repeated any suitable number of times. In the example illustrated in FIG. 8, step 1300 is repeated eight (8) times to provide eight (8) distinct images 300 for digital canvas 5. In one repetition, step 1300 comprises slicing an image 300B into two image components 300B-1, 300B-2, followed by rotating both of the two image components 300B-1, 300B-2, followed by positioning each of two image components 300B-1, 300B-2 at respective panels 202, 204. In another repetition, step 1300 comprises slicing an image 300C into two image components 300C-1, 300C-2, followed by rotating both the two image components 300C-1, 300C-2, followed by positioning each of two image components 300C-1, 300C-2 at respective panels 206, 208. In another repetition, step 1300 comprises slicing an image 300D into two image components 300D-1, 300D-2, followed by rotating both the two image components 300D-1, 300D-2, followed by positioning each of two image components 300D-1, 300D-2 at respective panels 206, 212. In another repetition, step 1300 comprises slicing an image 300E into two image components 300E-1, 300E-2, followed by rotating both the two image components 300E-1, 300E-2, followed by positioning each of two image components 300E-1, 300E-2 at respective panels 208, 210. In other repetitions, step 1300 comprises rotating images 300G to a desired orientation within a configuration of the folded object (as defined by the specification), followed by positioning the rotated image 300G at an appropriate panel (as defined by the specification). The repetitions described above are for illustration and not intended to be limiting. Method 1000 may comprise any combination and any number of repetitions described above, or repetitions of the type described above.

In some embodiments, step 1300 comprises slicing an image 300 into two image components 300-1, 300-2, followed by rotating one or both of the image components 300-1, 300-2 into a desired orientation, followed by positioning a first image component 300-1 on a first digital canvas 5 for printing on a first side of sheet 10, and positioning a second image component 300-2 at a second digital canvas 5 for printing on a second side of sheet 10. Illustratively, the first image component 300-1 and second image component 300-2 should be positioned and oriented precisely on their respective digital canvases 5 to allow the image components 300-1, 300-2 to join together to form a coherent image when sheet 10 carrying the digital canvases 5 is folded (i.e., into an intermediate configuration or a folded configuration).

When it is determined at decision step 1400 that no additional images 300 need to be processed and added to digital canvas 5, method 1000 proceeds to step 1500. Step 1500 comprises exporting the digital canvas 5 into a digital image file. Digital canvas 5 may then be printed onto a sheet of paper 10.

Additional aspects of the invention are described with reference to FIG. 10.

FIG. 10 depicts an exemplary Graphical User Interface (GUI) of an image editing system according to an example embodiment. Image editing system and its GUI may be provided as part of a web-based image editing system, a browser-based image editing system, or a non-web-based image editing system. GUI provides a user friendly environment for providing digital images 300 and configuration specifications to a digital canvas construction engine of image editing system. The digital canvas construction engine automatically processes (e.g., slices, rotates, positions, etc.) images 300 based on the specifications and user inputs, in accordance with methods described herein, to create a digital canvas 5. The digital canvas 5 can be printed on a medium 10 that is foldable into an origami object 2, such as an origami envelope. When the medium comprising the digital canvas printed thereon is folded into the origami object 2, the images are formed on one or more surfaces of one or more configurations of the origami object 2.

In the example embodiment illustrated in FIG. 10, the GUI comprises a design area 100 and a plurality of tabs 102, 104, 106, 108. Tabs 102, 104, 106, 108 may be provided or otherwise customized in accordance with the configuration specification of the origami object. As described above, the specification includes data sets that describe the various configurations of the origami object 2. For example, the specification may comprise a first data set describing a folded configuration of an origami envelope 2 (e.g., see FIGS. 6A, 6B, 10, 10A) and a second data set describing an intermediate configuration of the origami envelope 2 (e.g., see FIGS. 5, 10B).

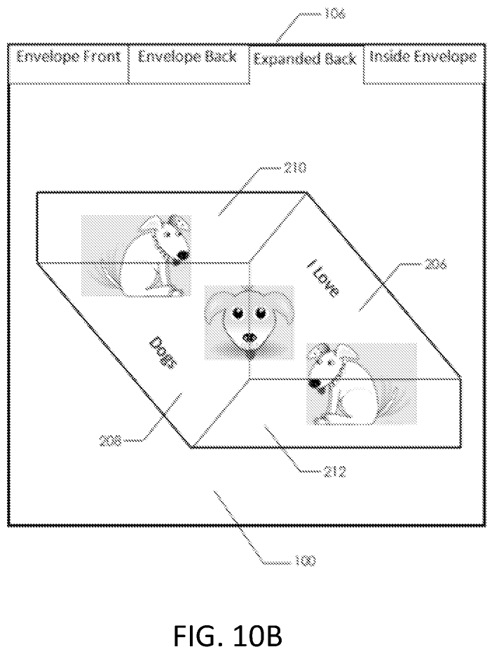

In the illustrated example embodiment, tabs 102, 104 are provided in accordance with the first data set describing the folded configuration of the origami envelope, and tab 106 is provided in accordance with the second data set describing an intermediate configuration of the origami envelope. Tab 102 may be selected by the user to show in design area 100 panel 200 corresponding to the front of the origami envelope 2 in its folded configuration (e.g., see FIG. 10). Tab 104 may be selected by the user to show in design area 100 panels 202, 204 corresponding to the back of the origami envelope 2 in its folded configuration (e.g., see FIG. 10A). Tab 106 may be selected by the user to provide in design area 100 panels 206, 208, 210, 212 corresponding to the back of the origami envelope 2 in its intermediate configuration (e.g., see FIG. 10B). Tab 108 may be selected by the user to display in design area 100 a panel corresponding to the inner surface (i.e., a writing surface) of the origami envelope 2 in its unfolded configuration (e.g., see FIGS. 9, 10C). Illustratively, tabs 102, 104, 106, 108 are provided to enable the user to navigate different panels or collection of panels. The panels are adjoined in design area 100 to allow the user to visualize the images 300 formed on the various surfaces of the various configurations of the origami envelope 2.

Referring back to FIG. 10, a front panel section 200 of digital canvas 5 is provided in design area 100 when the user selects tab 102. Design area 100 provides a means for the user to provide user input to customize the design of the panel section 200 of the digital canvas 5. For example, the user may select images from an image library 110 of the image editing system. The selected images are provided to the digital canvas construction engine for creating the digital canvas 5. In some embodiments, image library 110 is displayed as part of the GUI. In such embodiments, a user may select an image from image library 110 for input to the digital canvas construction engine by clicking the image and selecting an “Add” control 112 of the GUI, by dragging and dropping the selected image into design area 100, or the like.

Image library 110 may be configured to store stock images and/or images that are customized by or personal to the user (e.g., photos uploaded into the image editing system, etc.).

In some embodiments, the image editing system and GUI includes a “Delete” control 114 for deleting an inputted image from digital canvas construction engine. In some embodiments, the image editing system and GUI includes an “Add Text” control 116 for inputting a text box, or the like, to digital canvas construction engine. In the example illustrated in FIG. 10, an image of a carton and a text box containing an address of a recipient are provided to the digital canvas construction engine. The inputted image 300 and text box can be positioned on the front panel section 200 of the digital canvas, and the position can be precisely adjusted by user input. The user input may be provided by way of the user dragging image 300 across design area 100.

In some embodiments, the image editing system comprises additional graphic editing tools for editing an image 300 that has been inputted into the digital canvas construction engine. Such graphic editing tools may include a move tool for moving the inputted image 300 to a desired location of the digital canvas, a copy and paste tool for duplicating an inputted image 300, a delete tool for deleting an inputted image 300, a scaling tool for scaling an inputted image 300, a rotation tool for rotating an inputted image 300, etc.

In some embodiments, the inputted images 300, specification describing the configuration of the origami object 2, and user input can be saved together in a project file of the image editing system. In such embodiments, the image editing system and the GUI can include one or more of: a “Delete” control 122 for removing the selected project file, a “Save” control 124 for saving updated information to the project file, a “Finalize” control 126 for creating and exporting two image files for printing on to the medium, etc.

FIG. 10A illustrates back panel sections 202, 204 of the digital canvas. Back panel sections 202, 204 are displayed in design area 100 when the user selects tab 104. Back panel sections 202, 204 are defined according to the configuration specification of the origami object. In the example illustrated in FIG. 10A, back panel sections 202, 204 are adjoined to form the back the origami envelope 2 in its folded configuration. As shown in FIG. 10A, the inputted images may be placed entirely on back panel sections 202, 204, at an intersection between the back panel sections 202, 204 such that a first image component is positioned at a first back panel section 202 and a second image component is positioned at a second back panel section 204.

FIG. 10B illustrates panel sections 206, 208, 210, 212 of the digital canvas that collectively form the back of the origami envelope 2 in its intermediate configuration. Panel sections 206, 208, 210, 212 are displayed in design area 100 when the user selects tab 106. Panel sections 206, 208, 210, 212 are defined according to the configuration specification of the origami object. In the example illustrated in FIG. 10B, a first image has been placed at the intersection of panel section 210 and panel section 208, a second image has been placed at the intersection of panel section 206 and panel section 208, and a third image has been placed at the intersection of panel section 206 and panel section 212. In the example illustrated in FIG. 10B, a first text box is placed at first panel section 206 and a second text box is placed at second panel section 208.

FIG. 100 illustrates a panel section 214 of the digital canvas corresponding to the inside of the origami envelope. For the configuration specification corresponding to the origami envelope described herein, the panel section 214 corresponds to the entire rear surface of sheet 10. In some embodiments, panel section 214 can be customized for written correspondence. For example, panel section 214 may include guidelines for writing.

The examples and corresponding diagrams used herein are for illustrative purposes only. Different configurations and terminology can be used without departing from the principles expressed herein. Illustratively, the system and methods described herein may be provided in a stand-alone environment or through a network.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole. For example, various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a computer system for a device may implement methods as described herein by executing software instructions in a program memory accessible to the processors.

Processing may be centralized or distributed. In addition, while processes or blocks are presented in a given order (e.g., see FIG. 7), alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

Embodiments of the invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

The invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those to skilled in the art. For example, software and other modules may be accessible via local memory, via a network, via a browser or other application in a distributed computing context, or via other means suitable for the purposes described above.

1. A computer-implemented method for creating a digital canvas for printing on a medium foldable into a folded object, the method comprising:
receiving a specification comprising a first data set describing an intermediate configuration of the folded object and a second data set describing a folded configuration of the folded object;
initializing a background of the digital canvas based on the specification, the background defining an area corresponding to the size of the medium;
receiving a user input defining a position and an orientation of an image in at least one of the intermediate configuration and the folded configuration; and
placing the image onto the background at a location within the area, the location selected based on the specification and the user-defined position and orientation of the image.

2. The method according to claim 1, comprising:
slicing the image into two or more image components based on the user input and the specification; and
placing each of the two or more image components onto the background at respective locations within the area, the respective locations selected based on the specification and the user-defined position and orientation.

3. The method according to claim 2, wherein placing the two or more image components onto the background comprises rotating the two or more image components based on the specification and the user-defined position and orientation.

4. The method according to claim 2, wherein the user input defines a size of the image and placing the two or more image component onto the background comprises scaling the two or more image components based on the user-defined size.

5. The method according to claim 1, wherein the first data set defines one or more fold lines of the intermediate configuration, and wherein the second data set defines one or more fold lines of the folded configuration.

6. The method according to claim 5, wherein the first data set defines one or more intersections of the intermediate configuration, and wherein the second data set defines one or more intersections of the folded configuration.

7. The method according to claim 6, wherein the object is an origami envelope.

8. The method according to claim 7, wherein the defined one or more fold lines of the intermediate configuration and the defined one or more intersections of the intermediate configuration collectively define a plurality of panels on the digital canvas, the plurality of panels collectively forming a surface of the origami envelope in the intermediate configuration.

9. The method according to claim 8, wherein the plurality of panels include a first pair of corner panels and a second pair of corner panels.

10. The method according to claim 9, wherein the first pair of corner panels are irregular quadrilaterals.

11. The method according to claim 9, wherein the second pair of corner panels are right trapezoids.

12. The method according to claim 7, wherein the defined one or more fold lines of the folded configuration and the defined one or more intersections of the folded configuration collectively define a plurality of panels on the digital canvas, the plurality of panels forming a front surface and a back surface of the object in the folded configuration.

13. The method according to claim 12, wherein the plurality of panels include a main central panel corresponding to the front surface of the origami envelope in the folded configuration and a pair of side panels collectively forming the rear surface of the origami envelope in the folded configuration.

14. The method according to claim 13, wherein the main central panel is a convex hexagon.

15. The method according to claim 13, wherein the pair of side panels are irregular quadrilaterals.

16. The method according to claim 1, comprising:
receiving a first user input defining a position and an orientation of a first image in the intermediate configuration;
receiving a second user input defining a position and an orientation of a second image in the folded configuration; and
placing the first image onto the background at a location within the area based on the first data set and the first user input; and
placing the second image onto the background at a location within the area based on the second data set and the second user input.

17. The method according to claim 16, comprising:
slicing the first image into two or more image components based on the first user input and the first data set; and
placing each of the two or more image components onto the background at respective locations within the area, the respective locations selected based on the first user input and the first data set.

18. A method of constructing an origami envelope comprising,
printing the digital canvas created using the method of claim 1, on a first side of the medium; and
folding the medium into the origami envelope by performing a sequence of folds, wherein the sequence of folds are defined based on the intermediate configuration and the folded configuration.

19. A system for constructing a foldable object comprising:
a computer configured to generate a digital canvas by performing the method of claim 1; and
a printing machine configured to print the digital canvas onto a sheet.
